(19) United States
(12) Patent Application Publication
(10) Pub. No.: US 2026/0177531 A1
(43) Pub. Date: Jun. 25, 2026

(54) CHROMATOGRAPH SYSTEM

(71) Applicant: SHIMADZU CORPORATION, Kyoto (JP)

(72) Inventors: Yusuke NAGAI, Kyoto (JP); Yosuke IWATA, Kyoto (JP)

(73) Assignee: SHIMADZU CORPORATION, Kyoto (JP)

(21) Appl. No.: 19/545,624

(22) Filed: Feb. 20, 2026

Related U.S. Application Data
(63) Continuation of application No. 17/782,656, filed on Jun. 5, 2022, now abandoned.

(51) Int. Cl. G01N 30/60; G01N 30/86; G01N 30/02

(52) U.S. Cl. CPC G01N 30/60; G01N 30/8631; G01N 2030/027

(57) ABSTRACT

A first liquid raw material and a second liquid raw material are reacted with each other by a reactor of a reaction device, so that a reaction product is produced. The reaction product is analyzed by an analyzer. In the controller, the reference value is acquired by the reference value acquirer from the chromatogram obtained from the result of the analysis by the analyzer. An upper limit value and a lower limit value with respect to the reference value are set by an allowable range setter. At least one of a residence time of the first liquid raw material, a residence time of the second liquid raw material, a reaction temperature, and a reaction pressure in the reactor is dynamically changed as a control target by a reaction controller such that the reference value falls between the upper limit value and the lower limit value.

### TECHNICAL FIELD

The present invention relates to a chromatograph system.

### BACKGROUND ART

In a chromatograph system for monitoring, a part of products such as chemicals, food or chemical substances obtained by a reaction (hereinafter referred to as a reaction product) is extracted as a sample from a production line or the like. The extracted sample is transferred to an analysis chamber and analyzed by a liquid chromatograph, for example. This makes it possible to check whether a predetermined quality of the reaction product is secured. In recent years, a research for automating the aforementioned steps has been carried out to manage the quality of the reaction product.

For example, in a microfluidic system described in a non-patent document 1, a plurality of reagents are reacted by a microreflector. A sample produced by the reaction is injected into an HPLC (High Performance Liquid Chromatograph) and analyzed, so that a yield of a predetermined component in the sample is evaluated. In accordance with an optimization algorithm, the similar analysis is repeated while parameters such as a residence time and a concentration of each reagent are changed to achieve a maximum yield of the component.

A patent document 1 or a patent document 2 also describes a system for carrying out the similar control based on a result of analysis by a liquid chromatograph. Also, a research is carried out on a system for carrying out optimization of parameters to optimize or maximize the reaction based on a result of analysis by an infrared spectroscopy or the like rather than the chromatograph. Such a system is described in a non-patent document 2, a non-patent document 3 or a patent document 3.

Patent Document 1 JP 2008-516219 A

Patent Document 2 JP 2015-520674 A

Patent Document 3 WO 2018/187745 A1

[Non-patent Document 1] Jonathan P. McMullen and Klavs F. Jansen, "An Automated Microfluidic System for Online Optimization in Chemical Synthesis", Organic Process Research & Development,2010, Volume 14, pp. 1169-1176

[Non-patent Document 2] Jason S. Moore and Klavs F. Jansen, "Automated Multitrajectory Method for Reaction Optimization in a Microfluidic System Using Online IR Analysis", Organic Process Research & Development, 2012, Volume 16, pp. 1409-1415

[Non-patent Document 3] Ryan A. Skilton, Andrew J. Parrott, Michael W. George, Martyn Poliakoff and Richard A. Bourne, "Real-Time Feedback Control Using Online Attenuated Total Reflection Fourier Transform Infrared (ATR FT-IR) Spectroscopy for Continuous Flow Optimization and Process Knowledge", APPLIED SPECTROSCOPY, 2013, Volume 67, pp. 1127-1131

### SUMMARY OF INVENTION

### Technical Problem

At the stage of the research, it is considered that it is possible to produce the optimized reaction product for a comparatively short period by use of the system as described in the patent documents 1 to 3. However, if it is impossible to continue to produce the reaction product in a continuously stable manner for a long period, it is difficult to put the system to practical use.

An object of the present invention is to provide a chromatograph system capable of continuing to produce a reaction product in a continuously stable manner.

### Solution to Problem

An aspect of the present invention relates to a chromatograph system including: an analyzer that is connected to a reaction device that includes a reactor that produces a reaction product by reacting a first liquid raw material with a second liquid raw material, and analyzes the reaction product produced by the reaction device; and a controller that controls an operation of the reaction device, wherein the controller includes a reference value acquirer that acquires a reference value from a chromatogram obtained from a result of analysis by the analyzer, an allowable range setter that sets an upper limit value and a lower limit value with respect to the reference value, and a reaction controller that dynamically changes at least one of a residence time of the first liquid raw material, a residence time of the second liquid raw material, a reaction temperature, and a reaction pressure in the reactor as a control target such that the reference value acquired by the reference value acquirer falls between the upper limit value and the lower limit value set by the allowable range setter.

### Advantageous Effects of Invention

According to the present invention, it is possible to continue to produce a reaction product in a continuously stable manner.

### BRIEF DESCRIPTION OF THE DRAWINGS

FIG. 1 is a diagram showing a configuration of a chromatograph system according to one embodiment of the present invention.

FIG. 2 is a block diagram showing a configuration of a controller of FIG. 1.

FIG. 3 is a flowchart showing one example of an algorithm of a production analysis process executed by the controller.

FIG. 4 is a diagram showing a configuration of a chromatograph system according to a first modified example.

FIG. 5 is a block diagram showing a configuration of a controller of FIG. 4.

FIG. 6 is a diagram showing a configuration of a chromatograph system according to a second modified example.

FIG. 7 is a schematic diagram showing one example of a cleaner.

FIG. 8 is a schematic diagram showing one example of a cleaner.

### DESCRIPTION OF EMBODIMENTS

### (1) Configuration of Chromatograph System

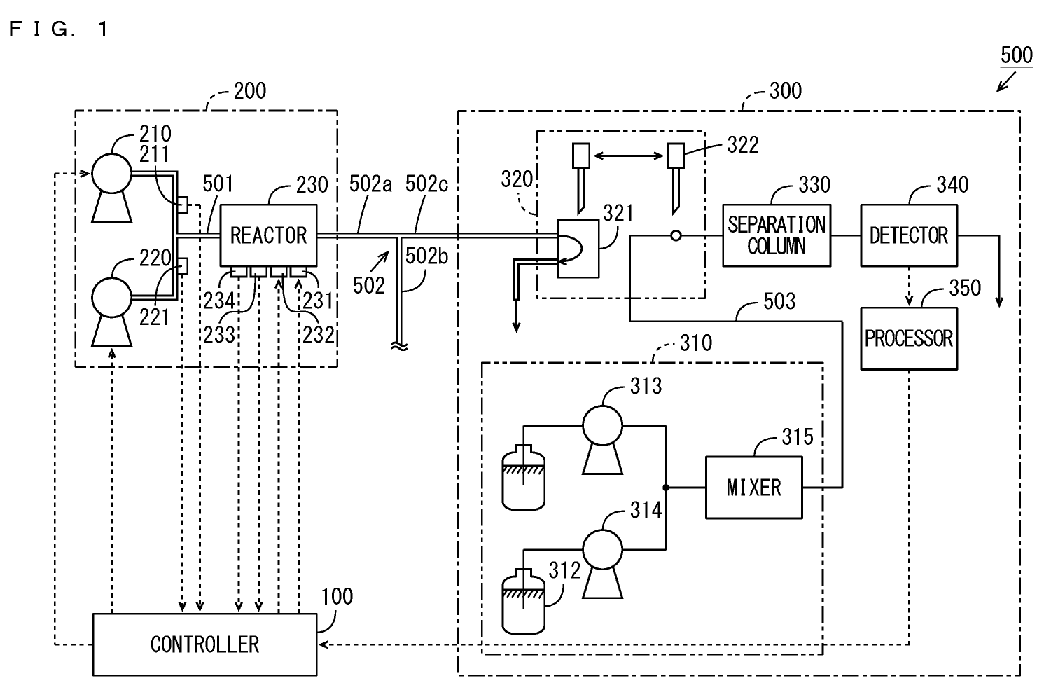

A chromatograph system according to embodiments of the present invention will now be described in detail with reference to the drawing. FIG. 1 is a diagram showing a configuration of a chromatograph system according to one embodiment of the present invention. As shown in FIG. 1, a chromatograph system 500 includes a controller 100, a reaction device 200, and an analyzer 300. In the present embodiment, the analyzer 300 is a liquid chromatograph that performs separation of a sample using an eluent.

The controller 100 is constituted by a computer, for example, and includes a CPU (Central Processing Unit) and a memory. The controller 100 acquires various results of detection from the reaction device 200, and also acquires a result of detection from the analyzer 300 to control an operation of the reaction device 200 based on the acquired results. Details of the controller 100 will be described below.

The reaction device 200 is provided in a batch production factory or the like that produces pharmaceutical products, food products or chemical products, for example, and includes liquid senders 210, 220, and a reactor 230. First and second liquid raw materials are supplied from factory equipment or the like to the liquid senders 210, 220, respectively. The liquid senders 210, 220 are liquid sending pumps, for example, and respectively pump the first and second liquid raw materials to the reactor 230 through a flow path 501. Flow rate sensors 211, 221 that respectively detect flow rates of the first and second liquid raw materials are provided at the flow path 501.

The reactor 230 includes a CSTR (Continuous Stirred Tank Reactor) or a plug flow reactor, for example, and continuously produces a predetermined product (hereinafter referred to as reaction product) by reacting the first liquid raw material with the second liquid raw material. The reactor 230 is provided with a thermoregulator 231 that regulates internal temperature and is also provided with a pressure regulation valve 232 that regulates internal pressure. Also, the reactor 230 is provided with a temperature sensor 233 and a pressure sensor 234 that respectively detect the internal temperature and the internal pressure.

An evaluation value indicating quality such as yield or purity of a reaction product produced by the reactor 230 changes in accordance with a residence time of the first liquid raw material, a residence time of the second liquid raw material, a reaction temperature or a reaction pressure in the reactor 230. The residence time of the first liquid raw material in the reactor 230 is determined by a liquid sending amount of the first liquid raw material and a flow path shape (volume) of the reactor 230. Similarly, the residence time of the second liquid raw material in the reactor 230 is determined by a liquid sending amount of the second liquid raw material and the flow path shape of the reactor 230.

A flow path 502 that includes a main pipe 502a and branch pipes 502b, 502c is connected to a downstream portion of the reactor 230. Most of reaction products produced by the reactor 230 are sent as products or semi-manufactured products to a downstream of a production line of the factory through the branch pipe 502b branched from the main pipe 502a. On the other hand, some of the reaction products produced by the reactor 230 are led as samples to be analyzed to the analyzer 300 through the branch pipe 502c branched from the main pipe 502a. A pump for leading the reaction products from the reactor 230 to the flow path 502 may be provided.

In the present embodiment, each of a cross-sectional area of the flow path 501 through which the first or second liquid raw material flows and a cross-sectional area of the flow path 502 through which a reaction product flows is larger than a cross-sectional area of a flow path 503, described below, through which an eluent flows in the analyzer 300. In this case, in the reaction device 200, a large amount of reaction products are produced, and the produced reaction products can be sent to the downstream. On the other hand, in the analyzer 300, the samples are prevented from being diffused in the flow path 503, and separation performance of the samples can be improved.

The analyzer 300 includes an eluent supplier 310, a sample supplier 320, a separation column 330, a detector 340, and a processor 350. The analyzer 300 may be provided in the same factory as that in which the reaction device 200 is provided, and may be provided in a research facility different from the factory, in which the reaction device 200 is provided. Also, in a case where the controller 100 has the same function as that of the processor 350, the processor 350 need not be provided in the analyzer 300.

The eluent supplier 310 includes bottles 311, 312, liquid senders 313, 314, and a mixer 315. The bottles 311, 312 respectively store an aqueous solution and an organic solvent, for example, as eluents. The liquid senders 313, 314 are liquid sending pumps, for example, and respectively pump the eluents stored in the bottles 311, 312 through the flow path 503. The mixer 315 is a gradient mixer, for example. The mixer 315 mixes the eluents pumped by the liquid senders 313, 314 in an arbitrary proportion and supplies the mixed eluents while changing a mixing ratio of the eluents.

The sample supplier 320 is an autosampler, for example, and includes a flow vial 321 and a sampling needle 322. The sample produced by the reaction device 200 is led to the flow vial 321 through the flow path 502 and is subsequently discarded to a waste liquid portion not shown. The sampling needle 322 sucks the sample in the flow vial 321 and injects the sucked sample into the separation column 330 together with the eluent supplied by the eluent supplier 310. The sampling needle 322 is an example of a sample extractor. The sample injected into the separation column 330 may be diluted in the sample supplier 320 as appropriate.

The separation column 330 is accommodated within a column oven not shown and adjusted at a predetermined constant temperature. The separation column 330 separates the sample injected by the sample supplier 320 into components in accordance with a difference in chemical property or composition. The detector 340 includes an absorbance detector or an RI (a refractive index) detector, for example, and detects the components of the sample separated by the separation column 330. The sample that has passed through the detector 340 is discarded. In a case where the eluent may be mixed in the reaction device 200, the sample, which has passed through the detector 340 may be returned to the reaction device 200.

The processor 350 includes a CPU and a memory, or a microcomputer or the like and controls an operation of each of the eluent supplier 310, the sample supplier 320, the separation column 330 (column oven), and the detector 340. The processor 350 processes a result of detection by the detector 340 to generate a chromatogram or the like indicating a relationship between a retention time of each component and detection intensity. In a case where a GPC (Gel Permeation Chromatography) analysis is performed, the processor 350 may analyze the generated chromatogram to calculate an average molecular weight of the reaction product.

### (2) Controller

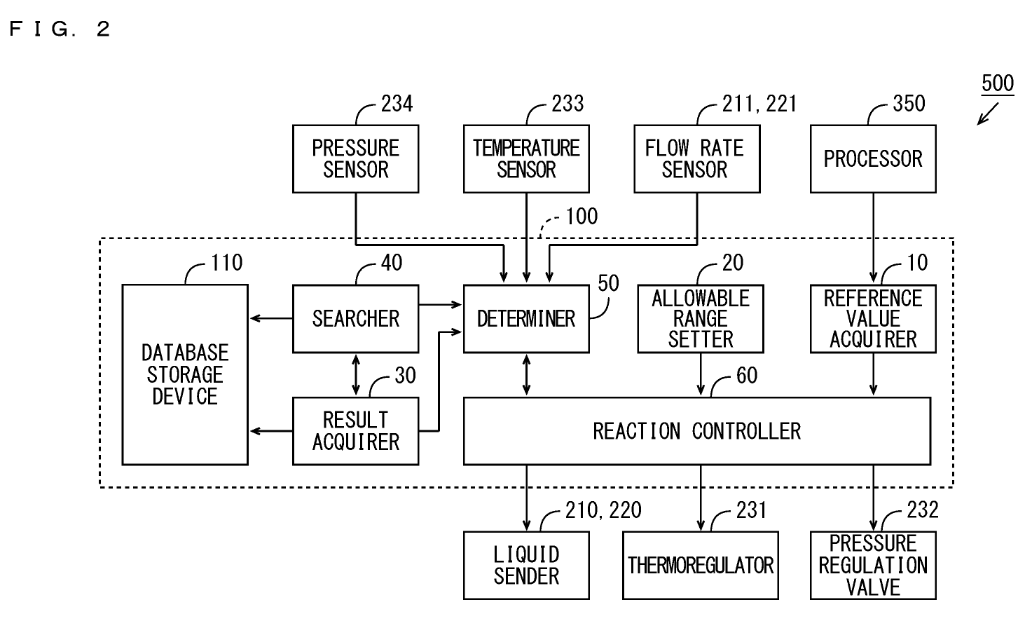

FIG. 2 is a block diagram showing the configuration of the controller 100 of FIG. 1. As shown in FIG. 2, the controller 100 includes, as function units, a reference value acquirer 10, an allowable range setter 20, a result acquirer 30, a searcher 40, a determiner 50, and a reaction controller 60, and also includes a database storage device 110. The CPU of the controller 100 executes a production analysis program stored in the memory, so that the function units of the controller 100 are implemented. Some or all of the function units of the controller 100 may be implemented by a hardware such as an electronic circuit.

The database storage device 110 includes a large-capacity data server or the like that stores a database. The database may include a result of analysis in the past on a reaction product. The result of past analysis may include a result of past analysis obtained by the analyzer 300 of FIG. 1 and may include a result of past analysis obtained by another analyzer and published on a document. The database may include a design space indicating a relationship between the evaluation value indicating the quality of the reaction product and a combination of the residence time of the first liquid raw material, the residence time of the second liquid raw material, the reaction temperature, and the reaction pressure.

The reference value acquirer 10 repetitively acquires a reference value from the chromatogram generated by the processor 350 at predetermined intervals. Here, a user can designate a desired peak in the chromatogram for the reference value acquirer 10. A reference value may be a magnitude of the designated peak. The magnitude of the peak may be the area of the peak and may be the height of the peak. This similarly applies to the description provided below.

The reference value may be a ratio between the magnitude of the designated peak and that of another peak. The other peak may be a peak adjacent to the designated peak. Alternatively, the other peak may also be designated by the user. Also, the reference value may be the average molecular weight calculated by the processor 350. The average molecular weight includes any one or all of a number average molecular weight, a weight-average molecular weight, and a Z-average molecular weight.

The allowable range setter 20 sets an upper limit value and a lower limit value with respect to the reference value acquired by the reference value acquirer 10. The user can designate for the allowable range setter 20 the upper limit value and the lower limit value with respect to a reference value to be set in order for the reaction product to satisfy a predetermined quality.

The result acquirer 30 acquires the result of past analysis on the designated reaction product from the database storage device 110. The user can designate a desired reaction product for the result acquirer 30. In a case where the controller 100 is connected to the Internet or the like, the result acquirer 30 may acquire the result of the past analysis on the designated reaction product from an external server or the like.

The result acquirer 30 may present to the user a peak to be designated in the chromatogram based on analysis conditions in the acquired result of the past analysis or the type of the reaction product and so on. In this case, the user can easily designate a desired peak in the chromatogram for the reference value acquirer 10. Alternatively, the result acquirer 30 may present to the user an upper limit value and a lower limit value to be designated with respect to the reference value based on the acquired result of the past analysis. In this case, the user can easily designate an appropriate upper limit value and an appropriate lower limit value with respect to the reference value for the allowable range setter 20.

The searcher 40 searches for a design space with respect to the designated reaction product on the database storage device 110. The user can designate a desired reaction product for the searcher 40. In a case where the controller 100 is connected to the Internet or the like, the searcher 40 may search for the design space with respect to the designated reaction product on the external server or the like.

The determiner 50 acquires the liquid sending amount of the first liquid raw material, the liquid sending amount of the second liquid raw material, the reaction temperature, and the reaction pressure from the flow rate sensor 211, the flow rate sensor 221, the temperature sensor 233, and the pressure sensor 234, respectively. Also, the determiner 50 calculates the respective residence times of the first and second liquid raw materials in the reactor 230 based on the respective liquid sending amounts of the first and second liquid raw materials.

Further, the determiner 50 determines at least one control target to be changed by the reaction controller 60 among the residence time of the first liquid raw material, the residence time of the second liquid raw material, the reaction temperature, and the reaction pressure in the reactor 230. Here, the control target may be determined based on at least one of the result of the analysis acquired by the result acquirer 30 and the design space searched by the searcher 40. Alternatively, the control target may be determined based on the algorithm set by the user.

The reaction controller 60 dynamically changes the control target determined by the determiner 50 such that the reference value acquired by the reference value acquirer 10 falls between the upper limit value and the lower limit value set by the allowable range setter 20. The residence time of the first liquid raw material, the residence time of the second liquid raw material, the reaction temperature, and the reaction pressure can be changed by controlling the liquid sender 210, the liquid sender 220, the thermoregulator 231, and the pressure regulation valve 232, respectively.

### (3) Production Analysis Process

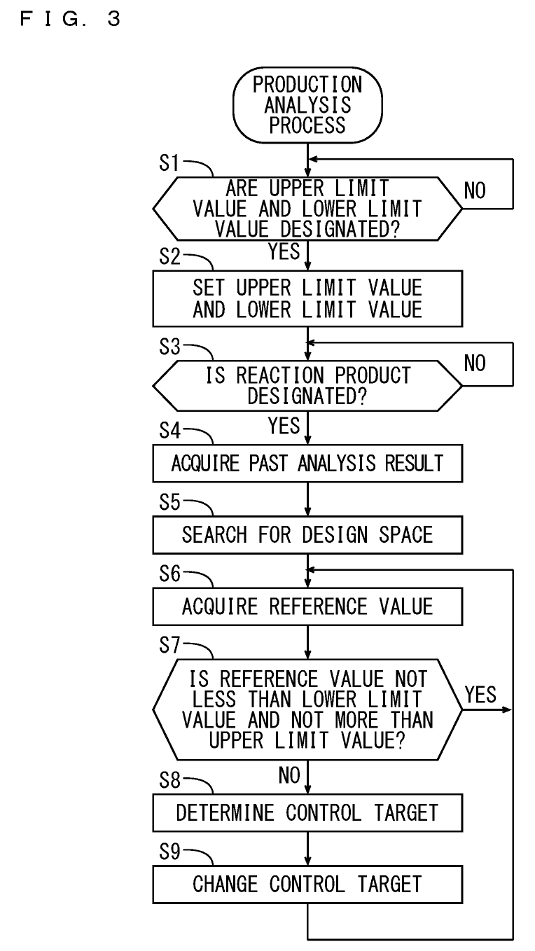

FIG. 3 is a flowchart showing one example of an algorithm of a production analysis process executed by the controller 100. The production analysis process is described below using the controller 100 of FIG. 2 and the flowchart of FIG. 3. First, the allowable range setter 20 determines whether an upper limit value and a lower limit value with respect to a reference value is designated (step S1). In a case where neither the upper limit value nor the lower limit value is designated, the allowable range setter 20 waits until the upper limit value and the lower limit value are designated. In a case where the upper limit value and the lower limit value are designated, the allowable range setter 20 sets the upper limit value and the lower limit value (step S2). While an example in which both the upper limit value and the lower limit value are designated is described below, only the upper limit value or only the lower limit value may be designated.

Then, the result acquirer 30 or the searcher 40 determines whether a reaction product is designated (step S3). In a case where the reaction product is not designated, the result acquirer 30 and the searcher 40 wait until the reaction product is designated. In a case where the reaction product is designated, the result acquirer 30 acquires a result of past analysis on the designated reaction product (step S4). The searcher 40 searches for a design space with respect to the designated reaction product (step S5). Either step S4 or step S5 may be executed in advance, and both of step S4 and step S5 may be simultaneously executed.

While step S3 is executed after steps S1, S2 are executed in the example of FIG. 3, the embodiment is not limited to this. Step S1 may be executed after steps S3 to S5 are executed. Alternatively, steps S1, S2 and steps S3 to S5 may be executed in parallel. In this case, the process proceeds to step S6 after steps S1 to S5 are terminated.

In step S6, the reference value acquirer 10 acquires a reference value from a chromatogram generated by the processor 350 (step S6). Here, in a case where the magnitude of any of peaks in the chromatogram is a reference value, the user can designate the peak in the chromatogram. This similarly applies to a case where a ratio between the magnitude of any of peaks and that of another peak is a reference value.

Subsequently, the reaction controller 60 determines whether the reference value acquired in step S6 is not less than the lower limit value and not more than the upper limit value set in step S2 (step S7). When the reference value is less than the lower limit value or when the reference value is more than the reference value, the determiner 50 determines at least one control target to be changed (step S8). This determination is carried out based on at least one of the result of the analysis acquired in step S4 and the design space searched in step S5 and the results of the detection by the flow rate sensors 211, 221, the temperature sensor 233, and the pressure sensor 234.

After that, the reaction controller 60 changes the control target determined in step S8 (step S9). When it is determined that the reference value is not less than the lower limit value and not more than the upper limit value in step S7 or when step S9 is executed, the process returns to step S6. In this case, steps S6, S7 or steps S6 to S9 are repeated. Thus, the control target is dynamically changed such that the reference value falls between the upper limit value and the lower limit value. After the process returns to step S6, the designation of the peak in the chromatogram need not be carried out.

Various pieces of information such as the type of a reaction product in the production analysis process, the history of determination of a control target, the control amount of the control target, the analysis conditions, the reference value, the upper limit value, and the lower limit value may be stored in the database storage device 110 as one result of analysis in which these pieces of information are associated with one another. Alternatively, the result of analysis may be stored in the external server or the like. This makes it possible to utilize the result of analysis as the result of past analysis.

### (4) First Modified Example

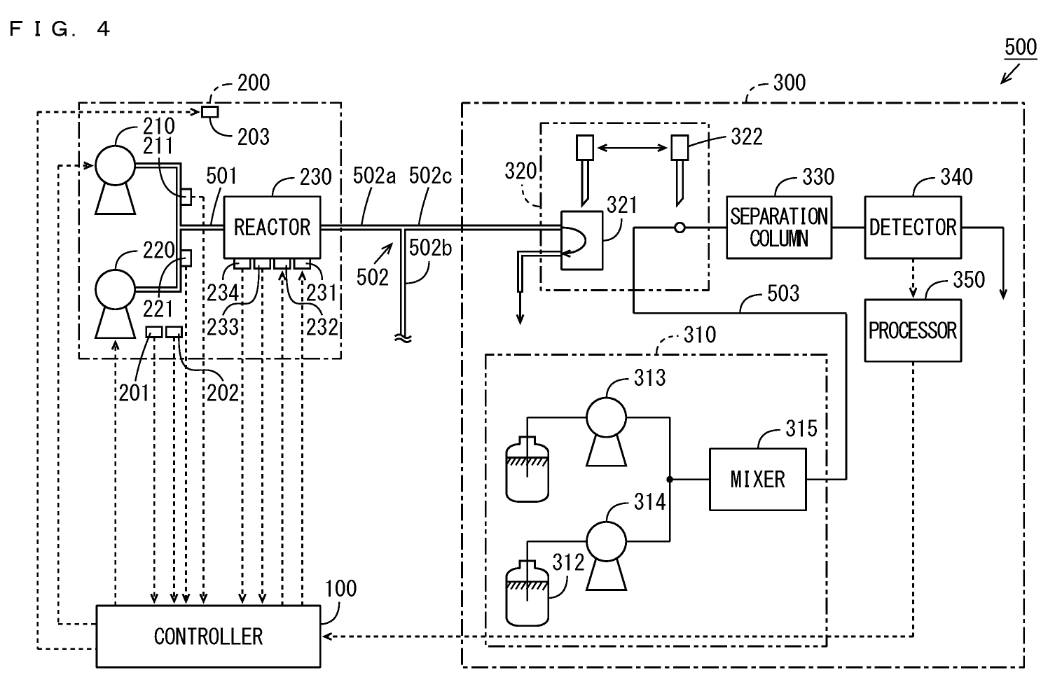

A chromatograph system 500 according to a first modified example will be described with respect to points different from the chromatograph system 500 of FIG. 1. FIG. 4 is a diagram showing the configuration of the chromatograph system 500 according to the first modified example. As shown in FIG. 4, a temperature sensor 201 and a humidity sensor 202 that respectively detect room temperature and humidity in a facility where the reaction device 200 is installed as a state of installation environment are further provided in the reaction device 200 in this example. Also, an air conditioner 203 that regulates at least one of the room temperature and the humidity in the facility is further provided in the reaction device 200.

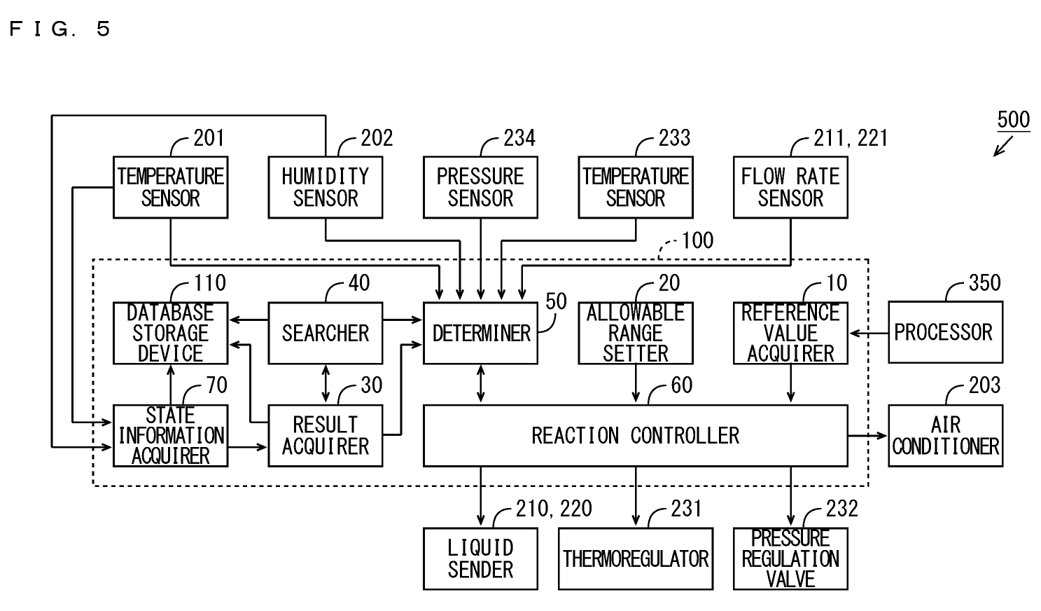

FIG. 5 is a block diagram showing the configuration of the controller 100 of FIG. 4. As shown in FIG. 5, the controller 100 further includes a state information acquirer 70 as a function unit. The state information acquirer 70 acquires state information indicating a usage state of the reaction device 200. The state information includes room temperature of the facility, humidity of the facility, weather, a user, an operation rate of the reaction device 200, a period of use of the reactor 230, a reaction product immediately before the reactor 230, or the like.

Here, the state information may be acquired from the database storage device 110. In a case where the controller 100 is connected to the Internet or the like, the state information may be acquired from the external server or the like. Among the state information, the room temperature and the humidity may be acquired from the temperature sensor 201 and the humidity sensor 202, respectively. Alternatively, the state information may be input to the state information acquirer 70 by the user.

The determiner 50 determines a control target by collating the state information acquired by the state information acquirer 70 with state information in the result of past analysis acquired by the result acquirer 30. In this case, a more appropriate control target can be determined. Also, the determiner 50 may acquire the room temperature and the humidity from the temperature sensor 201 and the humidity sensor 202, respectively, and determine at least one of the room temperature and the humidity as one of control targets.

The reaction controller 60 changes the control target determined by the determiner 50. In a case where the room temperature or the humidity is determined as the control target by the determiner 50, the reaction controller 60 changes the room temperature or the humidity such that the reference value acquired by the reference value acquirer 10 falls between the upper limit value and the lower limit value set by the allowable range setter 20. In this case, it becomes easy to control the residence time of the first liquid raw material, the residence time of the second liquid raw material, the reaction temperature or the reaction pressure with higher reproducibility. The room temperature or the humidity can be changed by controlling the air conditioner 203.

### (5) Second Modified Example

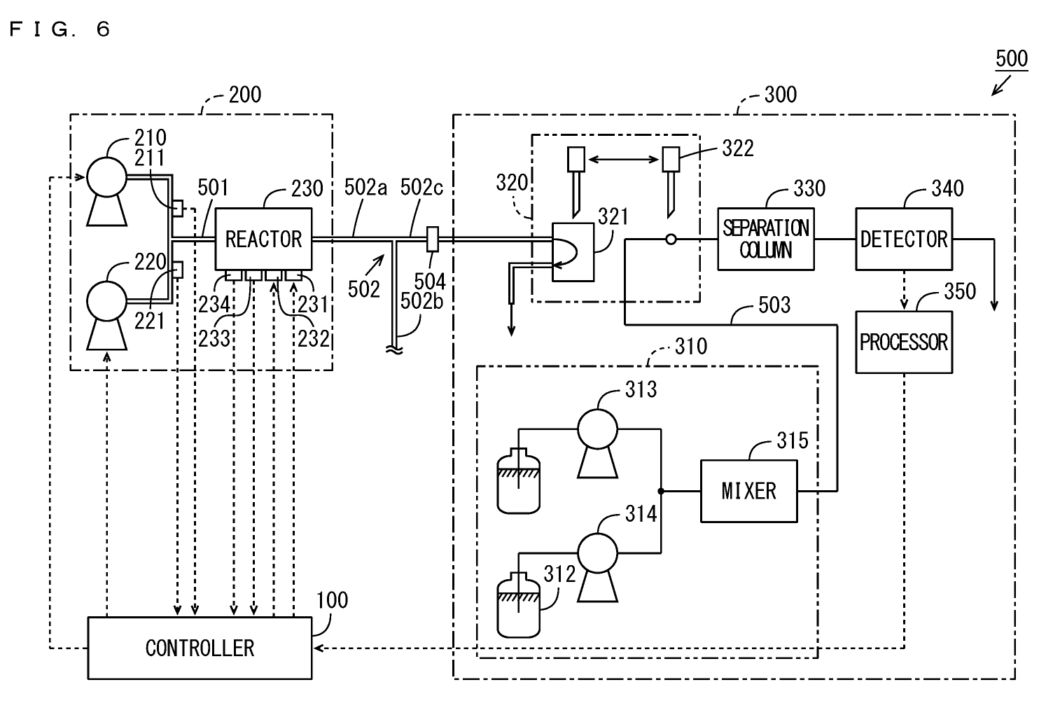

A chromatograph system 500 according to a second modified example will be described with respect to points different from the chromatograph system 500 of FIG. 1. FIG. 6 is a diagram showing the configuration of the chromatograph system 500 according to the second modified example. As shown in FIG. 6, in this example, a filter 504 is provided at a flow path 502 between the reactor 230 and the flow vial 321. In this case, an unnecessary component contained in the reaction product flowing through the flow path 502 is removed by the filter 504. The unnecessary component includes a foreign substance and a re-deposit.

With the configuration of this example, in a case where the reaction product has high concentration or high viscosity or even in a case where the flow path 503 has a small cross-sectional area (inner diameter), the flow path 503 is prevented from being blocked by the unnecessary component contained in the reaction product. While the filter 504 is provided at the branch pipe 502c of the flow path 502 in the example of FIG. 6, it may be provided at the main pipe 502a of the flow path 502. Also, the filter 504 and a cleaner described below may be provided in the chromatograph system 500 of the first modified example of FIG. 4.

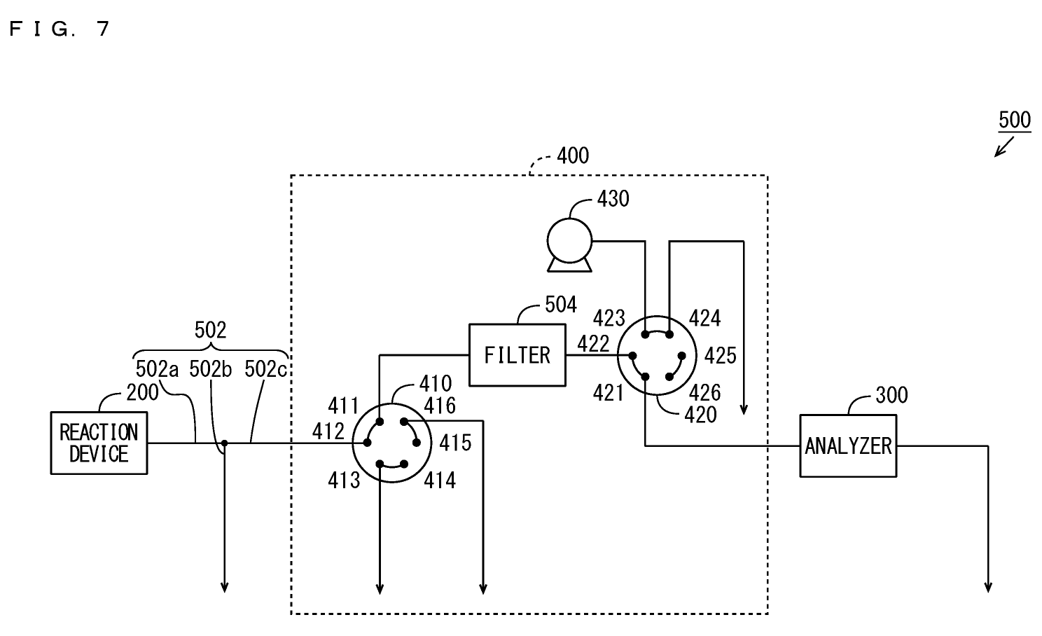

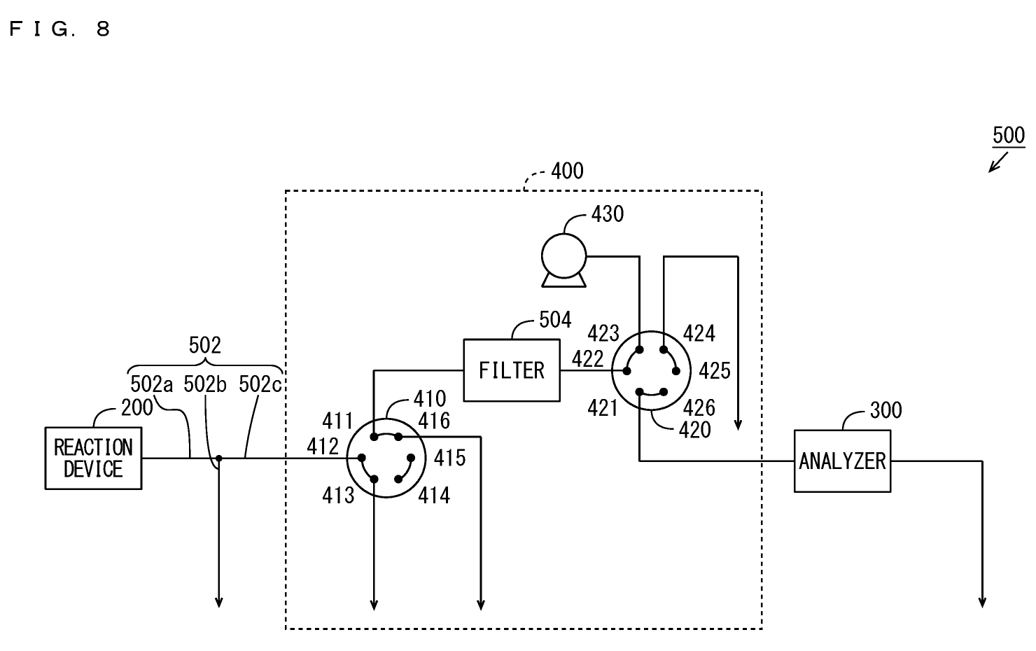

The chromatograph system 500 of this example may include a cleaner for cleaning the filter 504. FIGS. 7 and 8 are schematic diagrams showing one example of the cleaner. As shown in FIGS. 7 and 8, the cleaner 400 includes a flow path switching valves 410, 420 and a cleaning liquid supply pump 430. The flow path switching valve 410 has six ports 411 to 416, and the flow path switching valve 420 has six ports 421 to 426. The flow path switching valves 410, 420 are switchable between a first flow path state and a second flow path state and are provided between the branch pipes 502c of the flow path 502.

In the first flow state, the ports 411 and 412 communicate with each other, the ports 413 and 414 communicate with each other, and the ports 415 and 416 communicate with each other. Also, the ports 421 and 422 communicate with each other, the ports 423 and 424 communicate with each other, and the ports 425 and 426 communicate with each other. In the second flow state, the ports 412 and 413 communicate with each other, the ports 414 and 415 communicate with each other, and the ports 416 and 411 communicate with each other. Also, the ports 422 and 423 communicate with each other, the ports 424 and 425 communicate with each other, and the ports 426 and 421 communicate with each other.

The port 411 is connected to an upstream portion of the filter 504. The port 412 is connected to the reaction device 200 through the main pipe 502a. The port 421 is connected to the analyzer 300. The port 422 is connected to a downstream portion of the filter 504. The port 423 is connected to the cleaning liquid supply pump 430. The ports 413, 416, 424 are connected to a liquid drain device not shown. The ports 414, 415, 425, 426 are not connected to any units. The cleaning liquid supply pump 430 is configured to be capable of pumping the cleaning liquid.

As shown in FIG. 7, during an analysis of a sample, the flow path switching valves 410, 420 are put into the first flow path state. In this case, the reaction product from the reaction device 200 is led as the sample to the filter 504 through the ports 412, 411 of the flow path switching valve 410. The sample that has passed through the filter 504 is led to the analyzer 300 through the ports 422, 421 of the flow path switching valve 420. Thus, the sample is analyzed by the analyzer 300. On the other hand, the cleaning liquid pumped by the cleaning liquid supply pump 430 is led to the liquid drain device through the ports 423, 424 of the flow path switching valve 420. During the analysis of the sample, the cleaning liquid supply pump 430 need not operate.

As shown in FIG. 8, during cleaning of the filter 504, the flow path switching valves 410, 420 are put into the second flow path state. In this case, the cleaning liquid from the cleaning liquid supply pump 430 is led to the filter 504 through the ports 423, 422 of the flow path switching valve 420. The cleaning liquid passes through the filter 504, so that the filter 504 is cleaned. The cleaning liquid, which has passed through the filter 504 is led to the liquid drain device through the ports 411, 416 of the flow path switching valve 410. On the other hand, the sample from the reaction device 200 is led to the liquid drain device through the ports 412, 413 of the flow path switching valve 410.

With this configuration, the filter 504 is cleaned, so that the filter 504 is reproduced. As such, consumption of the filter 504 can be reduced, and a replacement cycle of the filter 504 can be extended. Thus, a running cost of the chromatograph system 500 can be reduced.

A flow path state of each of the flow path switching valves 410, 420 may be switched in response to the user’s instruction or may be automatically switched. For example, in a case where a predetermined period of time passes after the chromatograph system 500 starts to be operated, the flow path state of each of the flow path switching valves 410, 420 may be automatically switched such that the filter 504 is cleaned. Alternatively, in a case where a back pressure of the filter 504 increases to a predetermined value, the flow path state of each of the flow path switching valves 410, 420 may be automatically switched such that the filter 504 is cleaned.

### (6) Advantageous Effects of Invention

In the chromatograph system 500 according to the present embodiment, the first liquid raw material and the second liquid raw material are reacted with each other by the reactor 230 of the reaction device 200, so that a reaction product is produced. The reaction product produced by the reaction device 200 is analyzed by the analyzer 300.

In the controller 100, a reference value is acquired by the reference value acquirer 10 from a chromatogram obtained from a result of analysis by the analyzer 300. An upper limit value and a lower limit value with respect to the reference value are set by the allowable range setter 20. At least one of the residence time of the first liquid raw material, the residence time of the second liquid raw material, the reaction temperature, and the reaction pressure in the reactor 230 is dynamically changed as the control target by the reaction controller 60 such that the reference value acquired by the reference value acquirer 10 falls between the upper limit value and the lower limit value set by the allowable range setter 20.

With this configuration, in a case where the residence time of the first liquid raw material, the residence time of the second liquid raw material, the reaction temperature or the reaction pressure in the reactor 230 is varied, or even in a case where disturbance is generated in the reaction device 200, the control target is dynamically changed such that the reference value falls between the upper limit value and the lower limit value. As such, it becomes possible to continue to produce a reaction product that satisfies a predetermined quality in a continuously stable manner, such as a standard sample that has a predetermined concentration for producing a calibration curve.

Here, in a case where the magnitude of a peak in the chromatogram is used as the reference value, it is possible to continue to produce a reaction product having a predetermined yield, for example, in a continuously stable manner. In a case where the ratio of the magnitudes of peaks in the chromatogram is used as the reference value, it is possible to continue to produce a reaction product having a predetermined purity, for example, in a continuously stable manner. In a case where the average molecular weight of the reaction product is used as the reference value, it is possible to continue to produce a reaction product having a secure qualitative quality, for example, in a continuously stable manner.

### (7) Other Embodiments

(a) While the controller 100 includes the database storage device 110 in the above-described embodiment, embodiments are not limited to this. In a case where the result of past analysis on the reaction product or the design space with respect to the reaction product can be acquired from the external server or the like, the controller 100 need not include the database storage device 110.

(b) While the controller 100 includes the result acquirer 30 and the searcher 40 in the above-described embodiment, embodiments are not limited to this. In a case where the control target is determined not based on the result of past analysis on the reaction product, the controller 100 need not include the result acquirer 30. In a case where the control target is determined not based on the design space on the reaction product, the controller 100 need not include the searcher 40.

In a case where the control target is determined based on the algorithm set by the user, the controller 100 need not include either the result acquirer 30 or the searcher 40. Alternatively, similarly to method scouting, also in a case where the control target is sequentially determined such that a combination of production conditions of the reaction product is exhaustively changed, the controller 100 need not include either the result acquirer 30 or the searcher 40.

### (8) Aspects

The above-mentioned plurality of exemplary embodiments are understood as specific examples of the below-mentioned aspects by those skilled in the art.

(Item 1) A chromatograph system according to one aspect may include:

an analyzer that is connected to a reaction device that includes a reactor that produces a reaction product by reacting a first liquid raw material with a second liquid raw material, and analyzes the reaction product produced by the reaction device;

and a controller that controls an operation of the reaction device,

wherein the controller may include

a reference value acquirer that acquires a reference value from a chromatogram obtained from a result of analysis by the analyzer,

an allowable range setter that sets an upper limit value and a lower limit value with respect to the reference value, and

a reaction controller that dynamically changes at least one of a residence time of the first liquid raw material, a residence time of the second liquid raw material, a reaction temperature, and a reaction pressure in the reactor as a control target such that the reference value acquired by the reference value acquirer falls between the upper limit value and the lower limit value set by the allowable range setter.

In this chromatograph system, the first liquid raw material and the second liquid raw material are reacted with each other by the reactor of the reaction device, so that the reaction product is produced. The reaction product produced by the reaction device is analyzed by the analyzer. In the controller, the reference value is acquired by the reference value acquirer from the chromatogram obtained from the result of the analysis by the analyzer. The upper limit value and the lower limit value with respect to the reference value are set by the allowable range setter. At least one of the residence time of the first liquid raw material, the residence time of the second liquid raw material, the reaction temperature, and the reaction pressure in the reactor is dynamically changed as the control target by the reaction controller such that the reference value acquired by the reference value acquirer falls between the upper limit value and the lower limit value set by the allowable range setter.

With this configuration, in a case where the residence time of the first liquid raw material, the residence time of the second liquid raw material, the reaction temperature or the reaction pressure in the reactor is varied, or even in a case where disturbance is generated in the reaction device, the control target is dynamically changed such that the reference value falls between the upper limit value and the lower limit value. As such, it becomes possible to continue to produce a reaction product that satisfies a predetermined quality in a continuously stable manner.

(Item 2) In the chromatograph system according to item 1, the controller may further include

a result acquirer that acquires a result of past analysis on the reaction product, and

a first determiner that determines the control target to be changed by the reaction controller among the residence time of the first liquid raw material, the residence time of the second liquid raw material, the reaction temperature, and the reaction pressure in the reactor based on the result of the analysis acquired by the result acquirer.

In this case, an appropriate control target to be changed by the reaction controller can be easily determined based on the result of the past analysis on the reaction product.

(Item 3) In the chromatograph system according to item 2,

the controller may further include a state information acquirer that acquires state information indicating a usage state of the reaction device, and

the first determiner may determine the control target to be changed by the reaction controller further based on the state information acquired by the state information acquirer.

In this case, a more appropriate control target to be changed by the reaction controller can be easily determined further based on the usage state of the reaction device.

(Item 4) In the chromatograph system according to item 1 or 2, the controller may further include

a searcher that searches for a design space indicating a relationship between an evaluation value indicating a quality of the reaction product and a combination of the residence time of the first liquid raw material, the residence time of the second liquid raw material, the reaction temperature, and the reaction pressure, and

a second determiner that determines the control target to be changed by the reaction controller among the residence time of the first liquid raw material, the residence time of the second liquid raw material, the reaction temperature, and the reaction pressure in the reactor based on the relationship indicated in the design space searched by the searcher.

In this case, an appropriate control target to be changed by the reaction controller can be easily determined based on the relationship indicated in the design space.

(Item 5) In the chromatograph system according to item 1 or 2,

the reaction controller may change a state of installation environment where the reaction device is installed such that the reference value acquired by the reference value acquirer falls between the upper limit value and the lower limit value set by the allowable range setter.

In this case, the residence time of the first liquid raw material, the residence time of the second liquid raw material, the reaction temperature or the reaction pressure can be controlled with higher reproducibility.

(Item 6) In the chromatograph system according to item 1,

the reaction controller may dynamically change all of the residence time of the first liquid raw material, the residence time of the second liquid raw material, the reaction temperature, and the reaction pressure in the reactor as control targets such that the reference value acquired by the reference value acquirer falls between the upper limit value and the lower limit value set by the allowable range setter.

In this case, it becomes possible to continue to produce the reaction product that satisfies a predetermined quality in a continuously stable manner.

(Item 7) In the chromatograph system according to item 1 or 2,

the reference value may be a magnitude of any of peaks in the chromatogram.

In this case, it becomes easy to continue to produce the reaction product having a predetermined yield and so on in a continuously stable manner by use of the reference value.

(Item 8) In the chromatograph system according to item 1 or 2,

the reference value may be a ratio between the magnitude of any of the peaks and that of another peak in the chromatogram.

In this case, it becomes easy to continue to produce the reaction product having a predetermined purity and so on in a continuously stable manner by use of the reference value.

(Item 9) In the chromatograph system according to item 1 or 2,

the reference value may be an average molecular weight of the reaction product calculated from the chromatogram.

In this case, it becomes easy to continue to produce the reaction product having a secure qualitative quality in a continuously stable manner by use of the reference value.

(Item 10) In the chromatograph system according to item 1 or 2,

the analyzer may include

a flow vial in which a part of the reaction product produced by the reaction device flows as a sample to be analyzed,

a sample extractor that extracts the sample flowing in the flow vial,

a separation column that separates a component of the sample extracted by the sample extractor, and

a detector that detects the sample that passes the separation column.

In this case, the part of the reaction product can be easily analyzed as the sample to be analyzed.

(Item 11) In the chromatograph system according to item 10,

the chromatograph system may further include

a first flow path through which the first liquid raw material, the second liquid raw material or the reaction product flows at a position farther upstream than the flow vial, and

a second flow path through which an eluent for eluting the reaction product flows, and

a cross-sectional area of the second flow path may be smaller than that of the first flow path.

In this case, a large amount of reaction products can be produced by the reaction device at the position farther upstream than the flow vial. Also, separation performance of the sample by the analyzer can be improved.

(Item 12) In the chromatograph system according to item 11,

the chromatograph system may further include a filter that is provided at the flow path between the reactor and the flow vial and removes an unnecessary component contained in the reaction product.

With this configuration, in a case where the reaction product has high concentration and high viscosity, the second flow path is prevented from being blocked by the unnecessary component contained in the reaction product even in a case where the second flow path has a small cross-sectional area.

(Item 13) In the chromatograph system according to item 12,

the chromatograph system may further include a cleaner that cleans the filter.

In this case, the filter is cleaned, so that the filter is reproduced. As such, consumption of the filter can be reduced, and a replacement cycle of the filter can be extended. Thus, a running cost of the chromatograph system can be reduced.

1. A chromatographic analysis method including:
by using an analyzer that is connected to a reaction device that includes a reactor that produces a reaction product by reacting a first liquid raw material with a second liquid raw material, analyzing the reaction product produced by the reaction device; and
controlling an operation of the reaction device by a controller,
the analyzing the reaction product including:
acquiring a reference value from a chromatogram obtained from a result of analysis by the analyzer,
setting an upper limit value and a lower limit value with respect to the reference value, and
dynamically changing at least one of a residence time of the first liquid raw material, a residence time of the second liquid raw material, a reaction temperature, and a reaction pressure in the reactor as a control target such that the acquired reference value falls between the set upper limit value and the set lower limit value.

2. The chromatographic analysis method according to claim 1, wherein the analyzing the reaction product further includes
acquiring a result of past analysis on the reaction product, and
determining the control target to be changed among the residence time of the first liquid raw material, the residence time of the second liquid raw material, the reaction temperature, and the reaction pressure in the reactor based on the acquired result of the analysis.

3. The chromatographic analysis method according to claim 2, wherein the analyzing the reaction product further includes acquiring state information indicating a usage state of the reaction device, and
the determining the control target includes determining the control target to be changed further based on the acquired state information.

4. The chromatographic analysis method according to claim 1, wherein the analyzing the reaction product further includes
searching for a design space indicating a relationship between an evaluation value indicating a quality of the reaction product and a combination of the residence time of the first liquid raw material, the residence time of the second liquid raw material, the reaction temperature, and the reaction pressure, and
determining the control target to be changed among the residence time of the first liquid raw material, the residence time of the second liquid raw material, the reaction temperature, and the reaction pressure in the reactor based on the relationship indicated in the searched design space.

5. The chromatographic analysis method according to claim 1, wherein the dynamically changing at least one of a residence time of the first liquid raw material, a residence time of the second liquid raw material, a reaction temperature, and a reaction pressure as a control target includes further changing a state of installation environment where the reaction device is installed such that the acquired reference value falls between the set upper limit value and the set lower limit value.

6. The chromatographic analysis method according to claim 1, wherein the dynamically changing at least one of a residence time of the first liquid raw material, a residence time of the second liquid raw material, a reaction temperature, and a reaction pressure as a control target includes dynamically changing all of the residence time of the first liquid raw material, the residence time of the second liquid raw material, the reaction temperature, and the reaction pressure in the reactor as control targets such that the acquired reference value falls between the set upper limit value and the set lower limit value.

7. The chromatographic analysis method according to claim 1, wherein the reference value is a magnitude of any of peaks in the chromatogram.

8. The chromatographic analysis method according to claim 1, wherein the reference value is a ratio between a magnitude of any of peaks and a magnitude of another peak in the chromatogram.

9. The chromatographic analysis method according to claim 1, wherein the reference value is an average molecular weight of the reaction product calculated from the chromatogram.

10. The chromatographic analysis method according to claim 1, wherein the analyzing the reaction product includes
extracting a sample flowing in a flow vial in which a part of the reaction product produced by the reaction device flows as a sample to be analyzed,
separating a component of the extracted sample by a separation column, and
detecting the sample that passes the separation column by a detector.

11. The chromatographic analysis method according to claim 10, wherein
the first liquid raw material, the second liquid raw material or the reaction product flows through a first flow path at a position farther upstream than the flow vial; and
an eluent for eluting the reaction product flows through a second flow path,
wherein a cross-sectional area of the second flow path is smaller than a cross-sectional area of the first flow path.

12. The chromatographic analysis method according to claim 11, further including removing an unnecessary component contained in the reaction product by a filter that is provided at the first flow path between the reactor and the flow via.

13. The chromatographic analysis method according to claim 12, further including cleaning the filter by a cleaner.
